(19) United States
(12) Patent Application Publication
(10) Pub. No.: US 2014/0043724 A1
(43) Pub. Date: Feb. 13, 2014

(54) MULTILAYER CERAMIC ELECTRONIC PART AND FABRICATING METHOD THEREOF

(71) Applicant: SAMSUNG ELECTRO-MECHANICS CO., LTD., Suwon (KR)

(72) Inventors: Sung Koo KANG, Gyunggi-do (KR); Hyun Hee GU, Gyunggi-do (KR); Kyung Pyo HONG, Gyunggi-do (KR); Byung Jun JEON, Gyunggi-do (KR); Chang Hoon KIM, Gyunggi-do (KR)

(73) Assignee: SAMSUNG ELECTRO-MECHANICS CO., LTD., Suwon (KR)

(21) Appl. No.: 13/727,431

(22) Filed: Dec. 26, 2012

(30) Foreign Application Priority Data
Aug. 10, 2012 (KR) 10-2012-0087942

(51) Int. Cl. H01G 4/30; H01G 4/20

(52) U.S. Cl. CPC H01G 4/30; H01G 4/20
USPC 361/321.2; 156/89.12

(57) ABSTRACT

There is provided a multilayer ceramic electronic part having high reliability including: a ceramic body including a dielectric layer; internal electrodes formed in the ceramic body and disposed to face each other, having the dielectric layer interposed therebetween; an electrode layer formed on the exterior of the ceramic body and electrically connected to the internal electrodes; a conductive resin layer formed on the electrode layer; and a plating layer formed on the conductive resin layer, wherein the conductive resin layer includes a first conductive resin layer contacting the electrode layer, and a second conductive resin layer formed on the exterior of the first conductive resin layer, contacting the plating layer and having a resin content different from that of the first conductive resin layer.

### CROSS-REFERENCE TO RELATED APPLICATIONS

This application claims the priority of Korean Patent Application No. 10-2012-0087942 filed on Aug. 10, 2012, in the Korean Intellectual Property Office, the disclosure of which is incorporated herein by reference.

### BACKGROUND OF THE INVENTION

1. Field of the Invention

The present invention relates to a multilayer ceramic electronic part having improved warpage strength characteristics, peeling characteristics, and plating characteristics and a fabricating method thereof.

2. Description of the Related Art

Among ceramic electronic parts, multilayer ceramic capacitors are configured to include a plurality of stacked dielectric layers, internal electrodes disposed to face each other, having a dielectric layer interposed therebetween, and external electrodes electrically connected to the internal electrodes.

Multilayer ceramic capacitors have been widely used as components included in computers, mobile communications devices such as PDAs, mobile phones, and the like, due to advantages such as compactness, high capacity, ease of mounting, and the like.

Recently, as electronic products have been miniaturized and multi-functionalized, chip parts have also tended to be miniaturized and multi-functionalized. As a result, demand for compact, high-capacity multilayer ceramic electronic parts has increased.

To this end, a multilayer ceramic capacitor in which a large number of dielectric layers are stacked by making the thicknesses of the dielectric layers and the internal electrode layers thin has been fabricated and the external electrodes have also been thinned.

In addition, as many functions of devices and machines requiring high reliability such as cars, medical equipment, and the like, are digitalized and demand therefor is increased, the multilayer ceramic capacitor has also required to have high reliability.

Factors causing problems in implementing high reliability may include the permeation of a plating solution into a sintered ceramic body, the occurrence of cracks due to external impacts, and the like, which occur during the manufacturing process.

As a method for resolving the above problems, a method for improving reliability by absorbing external impacts and preventing a plating solution from permeating into a sintered ceramic body by applying a resin composition including a conductive material between an electrode layer and a plating layer of an external electrode has been used.

However, when the conductive resin layer is provided between the electrode layer and the plating layer of the external electrode, a problem in which a peeling phenomenon in which the electrode layer and the resin layer peel away from each other, as well as a problem in which a non-plating phenomenon between the plating layer and the resin layer, may occur.

Further, in order to provide products requiring high reliability such as electric products, high voltage products, and the like with desired specifications, multilayer ceramic electronic parts having increased reliability are required.

Therefore, external electrodes are also required to have higher warpage resistance characteristics.

### RELATED ART DOCUMENT

(Patent Document 1) JP Patent Laid-Open Publication No. 1996-162357

### SUMMARY OF THE INVENTION

An aspect of the present invention provides a multilayer ceramic electronic part having improved warpage strength characteristics, peeling characteristics, and plating characteristics and a fabricating method thereof.

According to an aspect of the present invention, there is provided a multilayer ceramic electronic part, including: a ceramic body including a dielectric layer; internal electrodes formed in the ceramic body and disposed to face each other, having the dielectric layer interposed therebetween; an electrode layer formed on the exterior of the ceramic body and electrically connected to the internal electrodes; a conductive resin layer formed on the electrode layer; and a plating layer formed on the conductive resin layer, wherein the conductive resin layer includes a first conductive resin layer contacting the electrode layer, and a second conductive resin layer formed on the exterior of the first conductive resin layer, contacting the plating layer and having a resin content different from that of the first conductive resin layer.

When an area occupied by metal in a cross section of the first conductive resin layer is represented by a and an area occupied by metal in a cross section of the second conductive resin layer is represented by b, a<b.

The resin content of the first conductive resin layer may be 10.0 to 50.0 wt %.

The resin content of the second conductive resin layer may be 5.0 to 9.5 wt %.

When a thickness of the first conductive resin layer is represented by p and a thickness of the second conductive resin layer is represented by q, p/q>1.

At least one conductive resin layer may be further included between the first conductive resin layer and the second conductive resin layer.

The conductive resin layer may include an epoxy-based resin.

According to another aspect of the present invention, there is provided a method of fabricating a multilayer ceramic electronic part, the method including: preparing a plurality of ceramic green sheets; forming internal electrode patterns on the plurality of ceramic green sheets; forming a ceramic laminate by stacking the ceramic green sheets on which the internal electrode patterns are formed; forming a ceramic sintered body by cutting and firing the ceramic laminate such that internal electrodes are alternately exposed from end surfaces thereof; forming electrode layers on both ends of the ceramic sintered body to be electrically connected to the internal electrodes; forming first conductive resin layers by applying a first conductive resin composition to the electrode layers; forming second conductive resin layers by applying a second conductive resin composition having a resin content different from that of the first conductive resin composition to the exterior of the first conductive resin layers; and forming plating layers on the second conductive resin layers.

When an area occupied by metal in a cross section of the first conductive resin layer is represented by a and an area occupied by metal in a cross section of the second conductive resin layer is represented by b, a<b.

The resin content of the first conductive resin composition may be 10.0 to 50.0 wt %.

The resin content of the second conductive resin composition may be 5.0 to 9.5 wt %.

When a thickness of the first conductive resin layer is represented by p and a thickness of the second conductive resin layer is represented by q, p/q>1.

The method may further include forming a plurality of conductive resin layers on the first conductive resin layer, between the forming of the first conductive resin layer and the forming of the second conductive resin layer.

The first conductive resin composition and the second conductive resin composition may include an epoxy-based resin.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a multilayer ceramic capacitor according to an embodiment of the present invention;

FIG. 2 is a cross-sectional view taken along line A-A′ of FIG. 1 according to the embodiment of the present invention;

FIG. 3 is a scanning electron microscope (SEM) image showing a cross section of the multilayer ceramic capacitor according to the embodiment of the present invention;

FIG. 4 is a cross-sectional view taken along line A-A′ of FIG. 1, according to another embodiment of the present invention;

FIG. 5 is a scanning electron microscope (SEM) image showing a plating layer formed on a conductive resin layer in which a resin content is 9%; and

FIG. 6 is a scanning electron microscope (SEM) image showing a plating layer formed on a conductive resin layer in which a resin content is 16%.

### DETAILED DESCRIPTION OF THE EMBODIMENTS

Hereinafter, embodiments of the present invention will be described with reference to the accompanying drawings.

However, embodiments of the present invention may be changed in several other forms and the scope of the present invention is not limited to the following described embodiments. Rather, these embodiments are provided so that this disclosure will be thorough and complete, and will fully convey the concept of the invention to those skilled in the art. In the drawings, the shapes and dimensions of components may be exaggerated for clarity, and the same reference numerals will be used throughout to designate the same or like components.

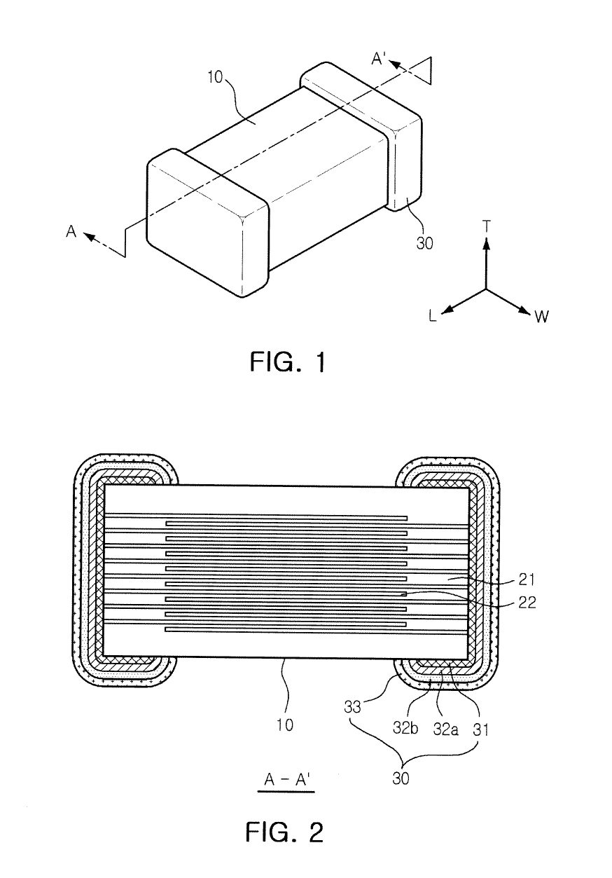

FIGS. 1 and 2 schematically illustrate a multilayer ceramic electronic part according to an embodiment of the present invention and respectively correspond to a perspective view and a cross-sectional view taken along line A-A′ of FIG. 1.

As shown in FIG. 2, the multilayer ceramic electronic part according to the embodiment of the present invention includes a ceramic body 10 including a dielectric layer 21, internal electrodes 22, an electrode layer 31, conductive resin layers 32a and 32b, and a plating layer 33. The internal electrodes are formed within the ceramic body 10 and may be disposed to face each other, having the dielectric layer 21 therebetween. The electrode layer 31 is formed on the exterior of the ceramic body 10 and may be electrically connected to the internal electrode 22. The conductive resin layers 32a and 32b are formed on the electrode layer and may be configured of a plurality of conductive resin layers having different resin contents. The plating layer 33 may be formed on the exterior of the conductive resin layers 32a and 32b.

A raw material forming the dielectric layer 21 is not particularly limited as long as sufficient capacitance can be obtained therewith. As the raw material, for example, a barium titanate (BaTiO3) powder may be used. Further, various types of ceramic additives, organic solvents, plasticizers, binding agents, dispersing agents, and the like, may be added to a powder such as a barium titanate (BaTiO3) powder, a material forming the dielectric layer 21 according to the purpose of the present invention.

A material forming the internal electrode 22 is not specifically limited. For example, the internal electrode 22 may be formed using a conductive paste formed of at least one of silver (Ag), lead (Pb), platinum (Pt), nickel (Ni), and copper (Cu).

The multilayer ceramic capacitor according to the embodiment of the present invention may include the electrode layer 31 electrically connected to the internal electrode 22. If a conductive metal used for the electrode layer 31 is electrically connected to the internal electrode 22 so as to form capacitance, any metal may be used without being particularly limited. For example, the metal may be at least one selected from a group consisting of copper (Cu), nickel (Ni), silver (Ag), and silver-palladium (Ag—Pd).

According to the embodiment of the present invention, the multilayer ceramic capacitor may include a first conductive resin layer 32a contacting the electrode layer 31 and a second conductive resin layer 32b formed on the exterior of the first conductive resin layer 32a and contacting the plating layer 33.

The first conductive resin layer 32a formed on the electrode layer 31 has a high resin content, thereby improving adhesion and warpage strength characteristics with the electrode layer 31, and the second conductive resin layer 32b contacting the plating layer 33 has a low resin content to resolve the non-plating problem, thereby improving the reliability of the multilayer ceramic electronic part.

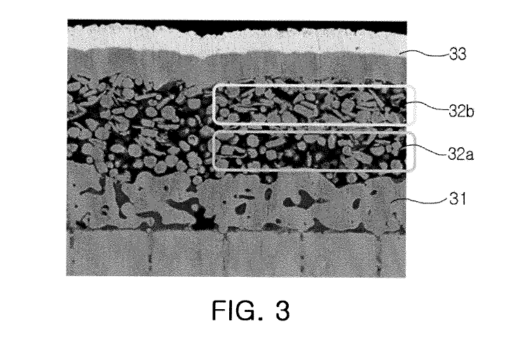

FIG. 3 is an enlarged image of part of a cross section taken along line A-A′ of the multilayer ceramic electronic part of FIG. 1 and shows the electrode layer 31, the first conductive resin layer 32a, the second conductive resin layer 32b, and the plating layer 33.

In FIG. 3, a dark portion in the image of the first conductive resin layer 32a and the second conductive resin layer 32b corresponds to resin and a light portion corresponds to the conductive metal.

As shown in FIG. 3, the first conductive resin layer 32a has a resin content higher than that of the second conductive resin layer 32b and therefore, an area occupied by metal in the cross section of the first conductive resin layer 32a is smaller than that of the second conductive resin layer 32b. Therefore, when the area occupied by metal in the cross section of the first conductive resin layer 32a is represented by a and the area occupied by metal in the cross section of the second conductive resin layer 32b is represented by b, a<b.

In more detail, the resin content of the first conductive resin layer 32a may be 10.0 to 50.0 wt %. When the resin content is less than 10.0 wt %, adhesion with the electrode layer 31 is reduced and thus, a peeling phenomenon may occur, and when the resin content exceeds 50.0 wt %, the conductivity is reduced and thus, a degradation in electrical contact may occur.

In addition, the resin content of the second conductive resin layer 32b may be 5.0 to 9.5 wt %. When the resin content is less than 5.0 wt %, the resin and the metal are dispersed and cannot be uniformly mixed, such that paste cannot be easily prepared. When the resin content exceeds 9.5 wt %, the non-plating problem may occur at the time of forming the plating layer 33 on the conductive resin layer.

In the embodiment of the present invention, the warpage strength characteristics are improved by the first conductive resin layer 32a and therefore, the first conductive resin layer 32a needs to be formed to be thicker than the second conductive resin layer 32b. Meanwhile, the second conductive resin layer 32b is provided to secure plating capabilities, and is independent of the thickness of the conductive resin layer and therefore, the second conductive resin layer 32b is sufficient to have a thickness that can be uniformly applied. Therefore, when the thickness of the first conductive resin layer 32a is represented by p and the thickness of the second conductive resin layer 32b is represented by q, p/q>1 may be satisfied.

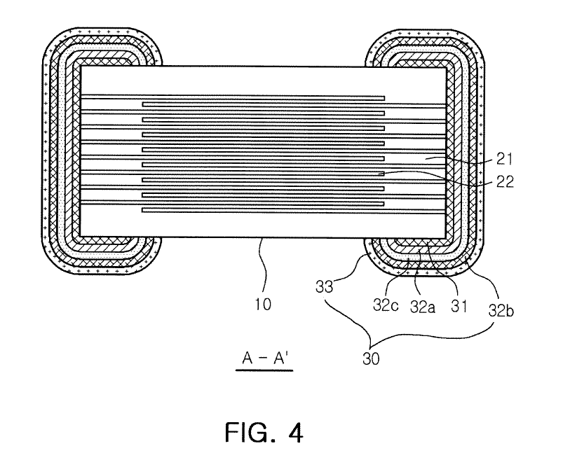

Further, as shown in FIG. 4, the multilayer ceramic capacitor according to another embodiment of the present invention may further include at least one conductive resin layer 32c between the first conductive resin layer 32a and the second conductive resin layer 32b.

The conductive resin layer 32c formed between the first conductive resin layer 32a and the second conductive resin layer 32b does not directly contact the electrode layer 31 or the plating layer 33 and therefore, is free of the peeling and non-plating problems. Therefore, the conductive resin layer 33c may include a resin and a conductive metal having a content that is the most appropriate for the warpage strength characteristics in a range in which conductivity is secured. In detail, the resin content that best shows warpage strength characteristics is 10.0 to 15.0 wt %.

Further, a plurality of layers capable of improving the reliability of the multilayer ceramic electronic part may be further provided between the first conductive resin layer 32a and the second conductive resin layer 32b, but they are not necessarily limited to the conductive resin layers.

If the resin included in the conductive resin layer has adhesion properties and shock absorption properties and is mixed with a conductive metal powder to prepare a paste, any resin may be used without being particularly limited. For example, an epoxy-based resin may be used.

If the conductive metal included in the conductive resin layer is electrically connected to the electrode layer 31, any metal may be used without being particularly limited. For example, the conductive metal may include at least one selected from a group consisting of silver (Ag), copper (Cu), nickel (Ni), and silver-palladium (Ag—Pd).

According to another embodiment of the present invention, a method of fabricating a multilayer ceramic capacitor includes: preparing a plurality of ceramic green sheets 21; forming internal electrode patterns 22 on the ceramic green sheets; forming a ceramic laminate by stacking the ceramic green sheets on which the internal electrode patterns are formed; forming a ceramic sintered body 10 by cutting and firing the ceramic laminate such that internal electrodes are alternately exposed from end surfaces thereof; forming electrode layers 31 on both ends of the ceramic sintered body 10 to be electrically connected to the internal electrodes; forming first conductive resin layers 32a by applying a first conductive resin composition to the electrode layers 31; forming second conductive resin layers 32b by applying a second conductive resin composition to the exterior of the first conductive resin layers, the second conductive resin composition having a resin content different from that of the first conductive resin composition; and forming plating layers 33 on the second conductive resin layers.

The description of the method of fabricating the multilayer ceramic capacitor overlap the description of the multilayer ceramic capacitor according to the embodiment of the present invention and therefore, will be omitted herein.

The following Table 1 represents experimental data to illustrate plating capability, warpage strength characteristics, and peeling defect probability, in multilayer ceramic electronic parts (hereinafter, Example 1) to which a double conductive resin layer having different resin contents of 9% and 16% is applied, multilayer ceramic electronic parts (hereinafter, Comparative Example 1) to which a single conductive resin layer having a resin content of 9% is applied, and multilayer ceramic electronic parts (hereinafter, Comparative Example 2) to which a single conductive resin layer having a resin content of 16% is applied.

The plating capability test was performed by investigating the number of multilayer ceramic electronic parts having a plated area of 90% or more at the time of forming a plating layer on the conductive resin layer of each example, and the warpage strength test was performed by investigating the number of multilayer ceramic electronic parts having a degradation in capacity of 10% or more when the multilayer ceramic electronic parts of each example were warped by 5 mm. Further, the piezoelectric test was performed by measuring a pressing distance of a point at which the electrical signal is changed while pressing body portions of the multilayer ceramic electronic parts to a point of 15 mm at a speed of 1 mm/sec, and the peeling test was performed by investigating the number of multilayer ceramic electronic parts in which peeling between the electrode layer and the conductive resin layer occurred after the multilayer ceramic electronic parts of the examples were dipped in a Pb dipping apparatus at 300° C. for five seconds.

TABLE 1

| | Pating | | Piezoelectric | |
|---|---|---|---|---|
| | Capability | Warpage | Test | |
| | Test | Strength Test | (Distance in | |
| | (Plated Area | (Degradation | Change of | Peeling Test |
| | of 90% or | in Capacity of | Electric | (Peeling |
| | more) | 10% or More) | Energy) | Cccurrence) |
| Example 1 | 50/50 | 0/10 | 10.23 mm | 0/30 |
| Comparative | 50/50 | 8/10 | 5.23 mm | 32/50 |
| Example 1 | | | | |
| Comparative | 40/50 | 3/10 | 7.04 mm | 0/50 |
| Example 2 | | | | |

Referring to Table 1, it can be appreciated from Comparative Example 1 that the warpage strength characteristics and the piezoelectric characteristics were vulnerable and the peeling defects of the electrode layer and the conductive resin layer frequently occurred.

It can be appreciated from Comparative Example 2 that the warpage strength characteristics or the piezoelectric characteristics were relatively good and the occurrence rate of peeling was low, but the plating capability was significantly degraded.

On the other hand, Example 1 provided multilayer ceramic electronic parts having high reliability in which the plating capability, the warpage strength characteristics, and the piezoelectric characteristics were good and the occurrence rate of peeling was low.

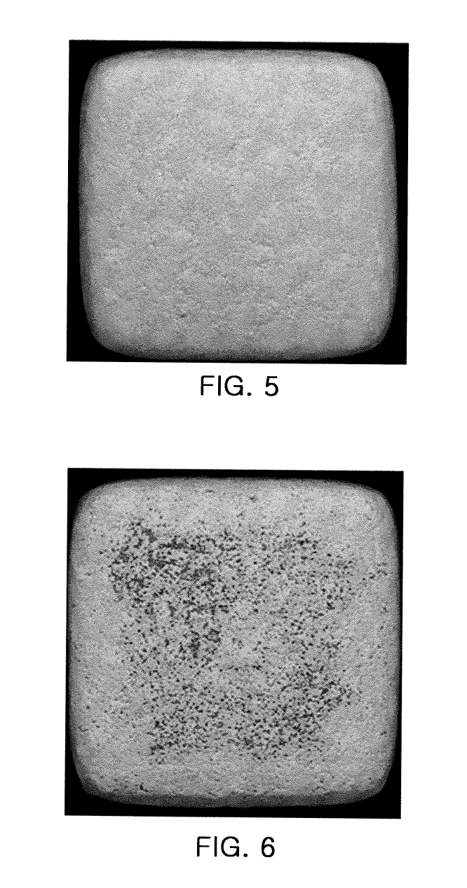

FIG. 5 is a scanning electron microscope (SEM) image showing the plating layer 33 formed on the conductive resin layer having a resin content of 9%, in which the plating state is very good.

FIG. 6 is a scanning electron microscope (SEM) image showing the plating layer 33 formed on the conductive resin layer having a resin content of 16%, in which partial non-plating occurs.

As set forth above, in the multilayer ceramic capacitor according to the embodiments of the present invention, high reliability thereof may be achieved by resolving the peeling problem occurring between the electrode layer and the resin layer and the non-plating problem occurring between the resin layer and the plating layer while retaining excellent warpage strength characteristics by using the plurality of conductive resin layers between the electrode layer 31 and the plating layer 33 of the multilayer ceramic capacitor. In addition, the multilayer ceramic capacitor according to the embodiment of the present invention can relieve acoustic noise.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic electronic part, comprising:
a ceramic body including a dielectric layer;
internal electrodes formed in the ceramic body and disposed to face each other, having the dielectric layer interposed therebetween;
an electrode layer formed on the exterior of the ceramic body and electrically connected to the internal electrodes;
a conductive resin layer formed on the electrode layer; and
a plating layer formed on the conductive resin layer,
wherein the conductive resin layer includes a first conductive resin layer contacting the electrode layer, and a second conductive resin layer formed on the exterior of the first conductive resin layer, contacting the plating layer and having a resin content different from that of the first conductive resin layer.

2. The multilayer ceramic electronic part of claim 1, wherein when an area occupied by metal in a cross section of the first conductive resin layer is represented by a and an area occupied by metal in a cross section of the second conductive resin layer is represented by b, a<b.

3. The multilayer ceramic electronic part of claim 1, wherein the resin content of the first conductive resin layer is 10.0 to 50.0 wt %.

4. The multilayer ceramic electronic part of claim 1, wherein the resin content of the second conductive resin layer is 5.0 to 9.5 wt %.

5. The multilayer ceramic electronic part of claim 1, wherein when a thickness of the first conductive resin layer is represented by p and a thickness of the second conductive resin layer is represented by q, p/q>1.

6. The multilayer ceramic electronic part of claim 1, wherein at least one conductive resin layer is further included between the first conductive resin layer and the second conductive resin layer.

7. The multilayer ceramic electronic part of claim 1, wherein the conductive resin layer includes an epoxy-based resin.

8. A method of fabricating a multilayer ceramic electronic part, the method comprising:
preparing a plurality of ceramic green sheets;
forming internal electrode patterns on the plurality of ceramic green sheets;
forming a ceramic laminate by stacking the ceramic green sheets on which the internal electrode patterns are formed;
forming a ceramic sintered body by cutting and firing the ceramic laminate such that internal electrodes are alternately exposed from end surfaces thereof;
forming electrode layers on both ends of the ceramic sintered body to be electrically connected to the internal electrodes;
forming first conductive resin layers by applying a first conductive resin composition to the electrode layers;
forming second conductive resin layers by applying a second conductive resin composition having a resin content different from that of the first conductive resin composition to the exterior of the first conductive resin layers; and
forming plating layers on the second conductive resin layers.

9. The method of claim 8, wherein when an area occupied by metal in a cross section of the first conductive resin layer is represented by a and an area occupied by metal in a cross section of the second conductive resin layer is represented by b, a<b.

10. The method of claim 8, wherein the first conductive resin composition is applied such that the resin content of the first conductive resin composition is 10.0 to 50.0 wt %.

11. The method of claim 8, wherein the second conductive resin composition is applied such that the resin content of the second conductive resin composition is 5.0 to 9.5 wt %.

12. The method of claim 8, wherein when a thickness of the first conductive resin layer is represented by p and a thickness of the second conductive resin layer is represented by q, p/q>1.

13. The method of claim 8, further comprising forming a plurality of conductive resin layers on the first conductive resin layer, between the forming of the first conductive resin layer and the forming of the second conductive resin layer.

14. The method of claim 8, wherein the first conductive resin composition and the second conductive resin composition include an epoxy-based resin.
